(19) United States
(12) Patent Application Publication
(10) Pub. No.: US 2025/0170735 A1
(43) Pub. Date: May 29, 2025

(54) Integrated hair maintenance system and method of using the same

(71) Applicants: Zijia Tiger LIU, Vancouver (CA); Mingchen Alex He, Beijing (CN); Xinran Jason WU, Princeton, NJ (US); Zeyu Darren Huang, Irvine, CA (US); Chifui William Ni, Shanghai (CN); Zhicheng Bruce Li, Shanghai (CN); Peixuan Sam Song, Xi'an (CN); Lisa Rousha Wang, Belle mead, NJ (US); Jian Jim Wang, Belle Mead, NJ (US)

(72) Inventors: Zijia Tiger LIU, Vancouver (CA); Mingchen Alex He, Beijing (CN); Xinran Jason WU, Princeton, NJ (US); Zeyu Darren Huang, Irvine, CA (US); Chifui William Ni, Shanghai (CN); Zhicheng Bruce Li, Shanghai (CN); Peixuan Sam Song, Xi'an (CN); Lisa Rousha Wang, Belle mead, NJ (US); Jian Jim Wang, Belle Mead, NJ (US)

(21) Appl. No.: 18/518,956

(22) Filed: Nov. 25, 2023

(51) Int. Cl. B26B 19/38

(52) U.S. Cl. CPC B26B 19/388

(57) ABSTRACT

The invention provides a programmable hair maintenance system designed comprising a device that accurately maps the user's head shape and hair length profile. The system can then adjust cutting members, for example, scissors and trimmers, based on the chosen hairstyle and execute the haircut with dynamic precision. More importantly, programmable hair maintenance system comprises a viewing assembly to integrated with a local controller and remote computing device to offer broader applications and better safety, which eliminates the necessity for the user to maintain their head in a static position during the haircut process.

### FIELD OF INVENTION

The present invention relates to programmable hair maintenance system and, more specifically, to an automated, programmable system for customized hair maintenance at home.

### BACKGROUND OF INVENTION

Scissors go back at least 2,000 years. Almost everyone learned to use a pair of scissors by entering Kindergarten. However, for many people, cutting hair today still require a skilled barber or hairdresser to do it. The skilled barber or hairdresser can manually cut and care the hair using scissors with a personal style. Because they are specifically trained in the art of cutting hairs. They study hair types and hairstyles, so they have an in-depth knowledge of classic styles like the undercut and pompadour. They also know what to recommend if you have any questions. However, this can be time-consuming, costly, and may not always produce consistent satisfying results.

The self-hair cut robot described in KR20210111514 features a hair trimmer part attached to an A-rail and a hair trimmer inlet. This invention leverages big data to set designs for various hairstyles and head shapes. It includes a gear system that enables the hair trimmer to adjust its angle from 0° to over 120°, claiming haircuts of different designs with just five rotations, promising personalized haircut designs.

On the other hand, Natrasevschi's patent, U.S. Pat. No. 4,602,542, outlines an automatic haircutting system. This system comprises a frame to position and stabilize the user's head, a robotic arm with a hair cutter, and a computer system for controlling these components. It also allows for the storage of individual hair cutting preferences. However, Natrasevschi's design necessitates the use of a frame to keep the head in a fixed position during operation, which raises safety concerns. This requirement limits the system's automation and adaptability, making it less of a universally applicable intelligent hair-cutting solution.

Robotic hair cut system, although particularly appealing in scenarios, where access to a professional hairdresser is limited, or for individuals who prefer a quick, standardized haircut. Nevertheless, several critical challenges remain in gaining widespread acceptance for this technology. These include ensuring absolute safety, achieving precision in haircutting, and personalizing the experience to suit individual preferences and unique head shapes. These factors significantly influence the trust users place in such technology, especially considering the traditional reliance on skilled human hairdressers for this task. To overcome these barriers, it is imperative that the system demonstrates not only safety and accuracy but also comfort and reliability. Successfully addressing these aspects is essential for encouraging the adoption of robotic hair cutting technology.

There is a need for an automated, customizable, and convenient hair cut solution that can provide precise and consistent haircuts in the comfort of a user's home with significant reliability.

### SUMMARY OF THE INVENTION

The invention provides a programmable hair maintenance system designed comprising a device that accurately maps the user's head shape and hair length profile. The programmable hair maintenance can then operate a cutting member, for example, scissors and trimmers, based on the chosen hairstyle and execute the haircut with precision. More importantly, programmable hair maintenance system comprises a viewing assembly to integrated with computer algorithms to offer broader applications and better safety.

Firstly, the present invention discloses a system and method for measuring scalp geometry and hair length. This approach utilizes advanced sensor technology and algorithms to accurately map the scalp's three-dimensional shape and determine the hair length distribution across the scalp. This precise measurement is fundamental in tailoring haircuts to individual head shapes and hair textures, representing a substantial improvement from traditional, less accurate methods.

Secondly, an important improvement feature of the invention is the dynamic adjustability of the robotic arms. This innovation eliminates the need for the user to remain stationary in a fixed position during the entire haircut. The robotic arms are designed to adapt and respond in real-time to the user's movements, ensuring continuous accuracy and precision throughout the haircutting process, thereby enhancing the user experience and efficiency of the service.

Thirdly, the invention integrates enhanced safety features aimed at increasing user trust and overcoming reliability concerns associated with robotic hair cutting. These features may include a comprehensive array of sensors—such as temperature, infrared, chemical, and mechanical sensors—that work synergistically to detect any potential risks or deviations during the haircutting process. By proactively addressing safety concerns, the invention paves the way for broader acceptance and use of robotic hair styling technologies.

In accordance with aspects of the present invention, on a first aspect, a programmable hair maintenance system is disclosed. Said programmable hair maintenance system comprises a support assembly, a viewing assembly, a positional-cut assembly, together with a one or more processors, part of a local controller or remote computing device, to control movement and determine adjustment for the positional-cut assembly. The programmable hair maintenance system further communicates to the user through a user interface. Additionally, the programmable hair maintenance system comprises a safety feature to prevent accidental cuts and injuries.

In the first aspect of the invention, said support assembly comprises a vertical or horizontal support member, anchored from a support surface. For example, the support surface can be floor, back of a chair, a side wall or a celling. The support assembly further comprises a guiding member, providing a guiding track for a positional-cut assembly to move to a target position.

In the first aspect of the invention, said viewing assembly comprises a plurality of sensors for obtaining a profile of a user's head and measuring hair length profile. The viewing assembly further comprises at least one camera.

In the first aspect of the invention, said positional-cut assembly, comprising a robotic arm, a lifting member and a cutting member, connected to the robotic arm. The robotic arm can move along the guiding member.

The robotic arm can move in five degrees of freedom, including left and right, up and down, and rotate. The lifting member in one example, is a comb structure, capable of holding a strand of hair between its teeth. The lifting member in another example, is hollow tube, connected to a vacuum pump, capable of gather and hold a strand of hair under slight negative pressure. The cutting member in one example is pair of scissors, the cutting member in another example is a trimmer.

In the first aspect of the invention, said user interface allows a user select and input desired hair styles.

Further, the programmable hair maintenance system comprises a local processing unit or remote computer device to take input from the viewing assembly, and send instructions for adjustments to positional-cut assembly based on hair length profile and chosen hairstyle.

Additionally, the programmable hair maintenance system comprises a safety feature to prevent accidental cuts or injuries to the user.

On a second aspect of the present invention, a new method of hair cutting is disclosed by using the programmable hair maintenance system.

It is one object of the present invention, to revolutionize hair maintenance by offering a convenient and personalized haircutting experience that can be enjoyed from the comfort of one's home. This eliminates the need to visit a salon or barber shop, saving both appointment and waiting times.

One of the key objectives of this invention is to provide a customizable hair maintenance solution. It allows a user to choose from a wide range of hairstyles, and the system's ability to accurately map the user's head and hair profile ensures each haircut is tailored to their individual needs and preferences. The hair profile includes, hair length, texture and density.

Another key objective of this invention is its focus on delivering consistent and reliable results. This is especially beneficial for busy professionals who often require regular hair trims rather than dramatic style changes. The system's precision in replicating desired hairstyles or maintaining a previously successful look ensures that users receive the same high-quality haircut every time, effectively reducing the risk of a bad haircut due to human error.

Lastly, another key objective of this invention is that the total solution designed with personal hygiene and disease prevention in mind. It features detachable members and elements that are easy to clean and maintain, offering a higher level of cleanliness compared to traditional hair cutting methods. This aspect of the design is particularly important in preventing the spread of contagious diseases, making it a safer option for personal grooming.

### BRIEF DESCRIPTION OF THE DRAWINGS

FIG. 1 shows an illustrative diagram of a programmable hair maintenance system according to the aspect of the invention;

FIG. 2 shows another illustrative diagram of a programmable hair maintenance system according to the aspect of the invention;

FIG. 3 shows schematic diagram of a programmable hair maintenance system according to the aspect of the invention;

FIG. 4 shows another schematic diagram of a programmable hair maintenance system according to the aspect of the invention;

FIG. 5 shows a process flow diagram of a programmable hair maintenance system according to the aspect of the invention.

FIG. 6 is a schematic illustration of the positional cut assembly in accordance with the aspects of the present invention;

FIG. 7 is a schematic illustration of the positional cut assembly lifting out a strand of hair with the aspects of the present invention;

FIGS. 8a and 8b are a schematic illustrations of operational range tilt angle of the positional cut assembly in accordance with the aspects of the present invention.

### DETAILED DESCRIPTION OF INSTANCES OF THE DISCLOSURE

The following will describe in great details the preferred instances of the present disclosure by combining with the accompanying drawings; however, the present disclosure is not restricted to these instances. The present disclosure covers any replacement, modification, equivalent methods and solutions made within the sprits and scopes of the present disclosure.

In order to make the public have a thorough understanding of the present disclosure, specific details are described in the following preferred instances of the present disclosure, while those skilled in the art can totally understand the present disclosure without these details.

The present disclosure is described in more details by way of illustration by referring to the accompanying drawings in the following paragraphs. It should be noted that the accompanying drawings all use simplified forms and use imprecise ratios and are merely for the objective of illustrating the instances of the present disclosure conveniently and clearly.

In the first aspect of the invention, said support assembly comprises a vertical or horizontal (lateral) support member, anchored from a support surface. For example, the support surface can be floor, back of a chair, a side wall, or a celling. The support assembly further comprises a guiding member, providing a guiding track for a positional-cut assembly to move to a target position.

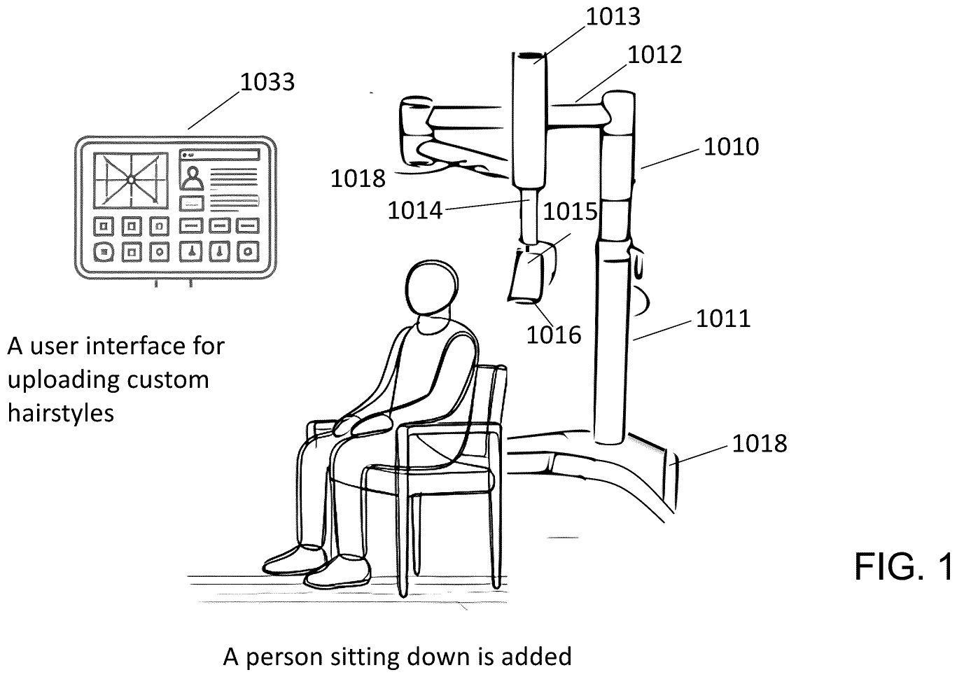

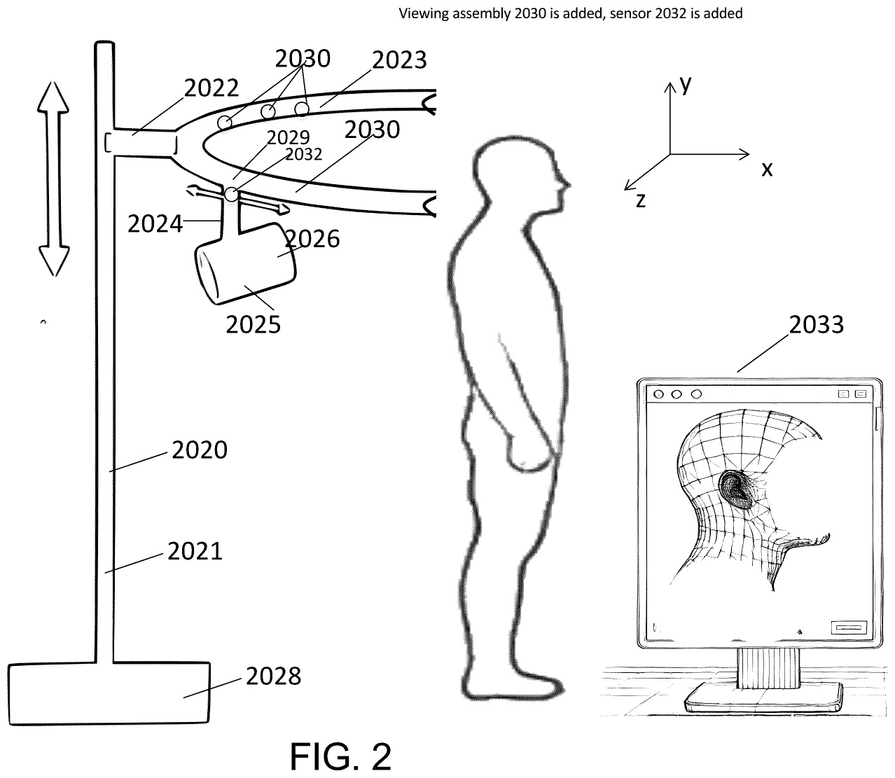

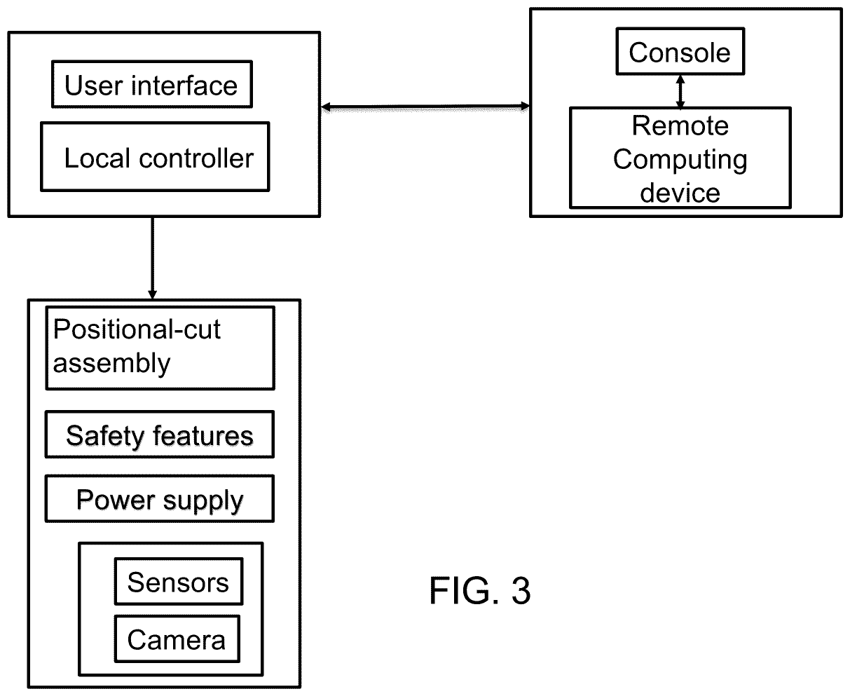

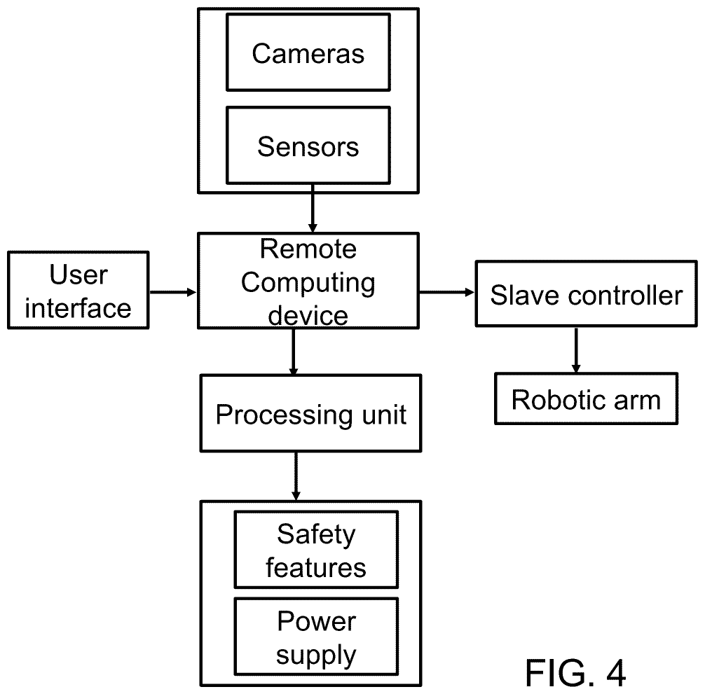

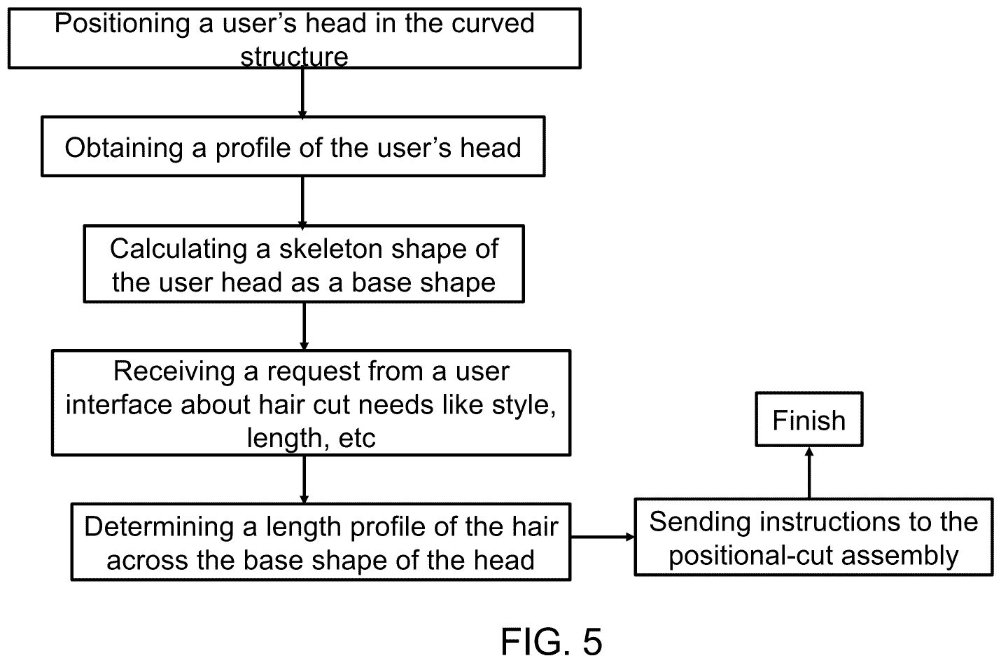

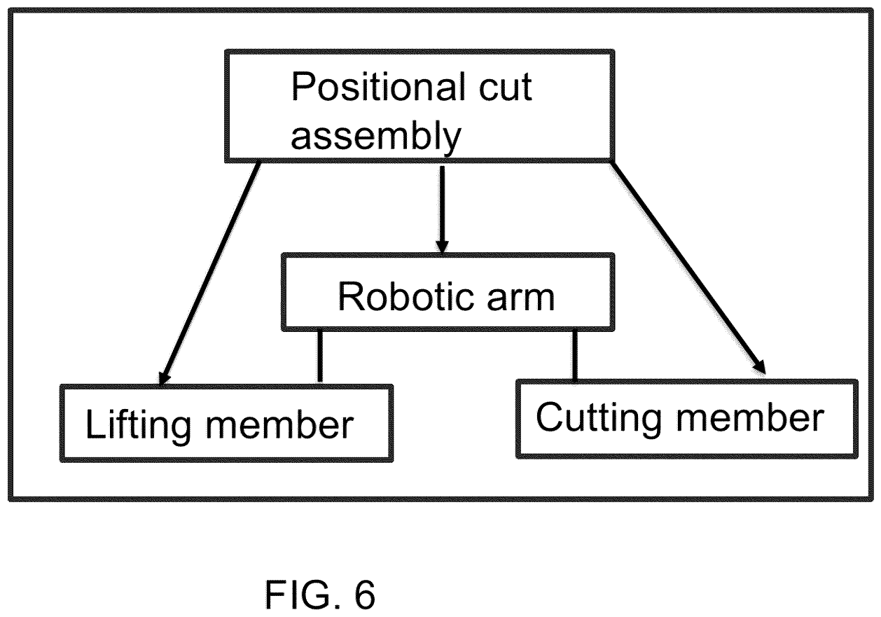

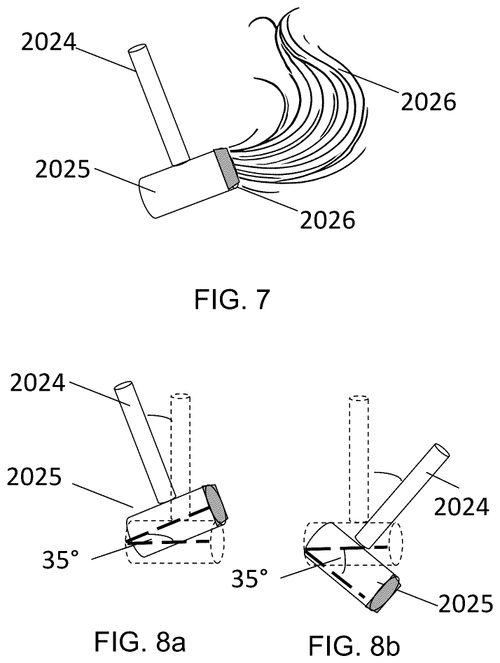

Referring to FIG. 1 and FIG. 2, in one example, the support assembly comprises vertical post, anchored from the ground. The vertical post, on one end, it is connected to a triangular or square shaped base. On the other end, it is connected to a lateral support member. The lateral support member extendedly connects to a guiding member, guiding member may further comprise rails to allow positional cut assembly to move along the guiding member horizontally, or vertically.

In one variation, the vertical support member is secured on a back of a chair.

In another variation, the vertical support member is secured to a wall. In still another variation, the vertical support member is hanging from the wall.

In one example, referring to FIG. 1, the vertical support member is supported on a base 1018 from 1011 the ground. A lateral or horizontal support member 1012 is directedly connected to the vertical support member 1011 and can move along the vertical support member, y direction and stop at any position. The lateral support member may further rotate around vertical member along y axis. Guiding member 1013 is connected to the lateral support member 1012 directly or through a bridge 1018. Guiding member 1013 is further attached to robotic arm 1014 which includes a mechanism allowing the positional cut assembly to move along inside of the guiding member. In one example, the mechanism is a rail. In another example, the mechanism is a channel.

In another example, referring to FIG. 2, the vertical support member 2020 is supported on a base 2028 from the ground. A lateral or horizontal support member 2022 is directedly connected to the vertical support member 2021 and can move along the vertical support member, y direction and stop at any position. The lateral support member can move in a 1-100 meters range, in order to allow a user, take the hair cut while sitting down or standing up. The lateral support member may further rotate around vertical member along y axis. Guiding member 2023 is connected to the lateral support member 2022 directly. Guiding member 2023 is further attached to robotic arm 2024 which includes a mechanism allowing the robotic arm and positional cut assembly to move along the guiding member, either through a rail or channel embedded on the top surface of the guiding member or on the bottom surface of the guiding member.

In one example, the guiding member has a curve structure, being part of oval ring, a diameter of the oval ring ranges from 25 cm to 50 cm. In one instance, the oval ring comprises a diameter ranging from approximately 25 cm to 30 cm. In a further instance, the diameter of the oval ring extends from approximately 31 cm to 35 cm. In yet another instance, the oval ring is characterized by a diameter spanning approximately 36 cm to 40 cm. Additionally, in a different instance, the oval ring encompasses a diameter ranging from about 41 cm to 45 cm. In yet another instance, the oval ring includes a diameter that ranges from approximately 46 cm to 50 cm.

As shown, the curved structure is a truncated oval ring. In one instance, the curved structure constitutes approximately 15% of the oval ring. In a further instance, the curved structure comprises about 20% of the oval ring. In another instance, the curved structure accounts for approximately 25% of the oval ring. Additionally, in a different instance, the curved structure encompasses around 30% of the oval ring. In yet another instance, the curved structure is characterized as being approximately 35% of the oval ring.

In a subsequent instance, the curved structure comprises roughly 45% of the oval ring. In another instance, the curved structure accounts for about 55% of the oval ring. Additionally, in a different instance, the curved structure constitutes approximately 60% of the oval ring. In yet another instance, the curved structure is characterized by covering around 65% of the oval ring.

Further, in another instance, the curved structure comprises approximately 70% of the oval ring. In a subsequent instance, the curved structure encompasses about 75% of the oval ring. Lastly, in another instance, the curved structure is characterized as constituting approximately 80% of the oval ring.

In one instance, the curved structure, forming a segment of an oval shape, is symmetrically configured with respect to the lateral support member. The design envisages that the curved structure aligns such that its central axis, an integral part of the oval configuration, extends in continuity with the lateral support member.

In another instance, the curved structure, while still constituting a segment of the oval shape, is asymmetrically aligned in relation to the lateral support member. This design variation features a shorter arm on one side of the curved structure, thereby improving the ease of entry and exit for users within the curved structure's area.

In a further instance, although the curved structure (a segment of the oval shape) is not symmetrical with respect to the lateral support member, its design maintains an alignment where the central axis of the oval, of which the curved structure is a part, extends as a continuation of the lateral support member. This instance also includes a shorter arm on one side of the curved structure to enhance user accessibility, specifically aiding in simpler and more efficient entry and exit.

In the first aspect of the invention, said positional-cut assembly, comprises a robotic arm, a lifting member, and a cutting member, connected to the robotic arm.

With reference to FIG. 2, the robotic arm is suspended and connected to the curved structure. This robotic arm is specifically engineered to traverse the length of the curved structure, capable of movement from one end to the other and having the capability to pause at any designated position along its path to start and finish its cutting job. Furthermore, the robotic arm is equipped with a connection to lifting member and cutting member of the positional cutting assembly. This assembly is adeptly designed to maneuver the lifting member and cutting member head both vertically (up and down) and horizontally (left and right), with an operational range of approximately ±35 degrees, thus offering precise and adjustable cutting positions.

The lifting member in one example, is a comb structure. The lifting member in another example, is hollow tube, connected to a vacuum pump. In a preferred example, the lifting member is a covered tube with holes at its end. These holes are ingeniously integrated into a vacuum subsystem. Upon activation, this vacuum subsystem initiates a suction process through these holes, effectively drawing and aligning individual strands or clusters of hair away from the user's scalp. Notably, the suction intensity of this system is adjustable and programmable, allowing for tailored settings based on the hair's thickness and length. This feature renders the module highly versatile, adept at accommodating a wide range of hair types with precision and ease.

The cutting member in one example is pair of scissors, the cutting member in another example is a trimmer. In one embodiment, both the lifting member and the cutting members are designed to be detachable from the robotic arm. This feature facilitates effortless cleaning and promotes efficient storage, enhancing the overall usability and maintenance of the system.

### Scalp Geometry Measurement and Automated Analysis

The primary improvement of this invention is the accurate mapping of the scalp's three-dimensional geometry. The system of the present invention introduces an automated solution for precise geometric measurement of the scalp and detailed analysis of hair length, essential for accurate hair styling. Conventional methods based on visual estimation are prone to inaccuracies. This invention combines ordinary hardware sensing with advanced software algorithms, for precise head geometry mapping. The measurement of hair length is executed using additional mechanical approach. The hardware sensing includes the use of array of infrared, radar sensors, temperature sensors alone, or in combination.

### Hardware Measurement

The gist of the present invention is the creative implementation of the viewing assembly, integrating a plurality of sensors and a high-resolution camera. The viewing assembly is essential for capturing the precise shape of the user's head, functional from the initial measurement phase through the final styling stages. In a first example, the sensors comprise an array of infrared or radar sensors to map out the scalp's 3D profile. The infrared sensors emit electromagnetic pulses that reflect off the scalp surface, enabling the creation of an accurate 3D scalp model.

In an alternative example, the sensors further comprise one or more temperature sensors, complementing the scalp map out process by detecting variations in temperature at the hair/scalp interface. The temperature differential is used to refine the 3D scalp profile.

In still another alternative example, the combined use of sensors and camera initially creates a three-dimensional digital model of the user's head. This model is further supplemented by temperature sensors, and a mechanical approach for assessing hair length. This method ensures a comprehensive acquisition of head geometry, including contours, dimensions, and overall shape.

### Head Shape Profiling:

In a first example, the sensors comprise an array of infrared or radar sensors to map out the scalp's 3D profile. The infrared sensors emit electromagnetic pulses that reflect off the scalp surface, enabling the creation of an accurate 3D scalp model.

In an optional example, the sensors further comprise one or more temperature sensors, complementing the scalp map out process by detecting variations in temperature at the hair/scalp interface. The temperature differential is used to refine the 3D scalp profile.

### Hair Length Profiling

Once the scalp shape is determined, the system calculates the hair length profile. This involves measuring the length of hair strands at various points on the scalp, creating a comprehensive map of hair length distribution. In a further example, mechanical methods involve a robotic arm equipped with a lifting member for example a vacuum tube. The end of tube is covered with holes. The lifting member gently lifts hair strands at specific scalp locations, moving from one end of the hair strand to the other end, measuring its length, or with the additional measurement from integrated infrared and temperature sensors for more accurate measurement at both ends of the strands.

### Head Shape and Hair Length Simultaneous Profiling:

The use of sensors and mechanical measurement method allows for simultaneous scalp profiling and hair length measurement. In a further embodiment, the sensors can work concurrently with the lifting member of the robotic arm, providing concurrently map the scalp's three-dimensional structure and determine hair length.

In the present invention, an IR sensor for head shape mapping works by emitting infrared light, detecting the reflected light, and then using the characteristics of this reflected light (such as time of flight and intensity) to determine the distances and contours of the head, thereby creating a detailed 3D map. This technology is useful in various applications, including precise hair styling systems.

First, the IR sensors will emit infrared light towards the head. The light is typically in the non-visible spectrum and is safe for human interactions. The infrared light is chosen for its properties of reflection and absorption, which vary based on the surface it encounters.

The emitted infrared light hits the scalp and hair, most of the light will be reflected back, the amount may depend on the characteristics of the surface. Different parts of the head (like hair, scalp, or skin) have unique properties that affect how much light is reflected or absorbed. For example, hair might reflect the light differently than the scalp.

Next, the IR sensor also includes a detector that captures the reflected infrared light.

The time it takes for the light to return to the sensor (time of flight), and the intensity of the reflected light, can provide information about the distance and characteristics of the surface it hit.

Then, in one example, an IR sensor is installed on the robotic arm. And moving the sensor around the head to collect data from various angles and points on the scalp. In another example, the one or more sensors are installed on the curved structure, at least two sensors are positioned opposing to each other to collect data from various angles and points on the scalp.

The sensor collects data points that represent the distance from the sensor to different parts of the head. These points are then used to create a three-dimensional map of the head.

Further, the collected data points are processed using algorithms that can construct a 3D model of the head's shape. This process can involves filtering out noise and interpolating between data points to create a smooth and accurate representation. In a simplified, subsequent, version, only selective spots are measured by the sensors and matching a preexisting library to determine the scalp shape. The pre-existing library may include the user's previous measurements.

### Sensor Integration and Data Processing:

In one example, the scape profiling is only performed by either an IR sensor or a temperature sensor to improve efficiency and save cost. In another example, when two kinds of sensors are used to achieve a high degree of precision, in this case, data fusion algorithms combine inputs from more than one type of sensors including infrared, radar, and temperature sensors, to create an accurate and comprehensive model of the scalp and hair.

With the purpose of the present invention in mind, head shape profiling, not only map out a general contour of the head, but determines critical boundary conditions as well. Boundary conditions like hair lines, position of the ears, are strictly defined and labeled on the map. In an optional or preferred example, infrared sensors operate within specific wavelength ranges to ensure accurate surface mapping without discomfort to the skin.

### Profiling by Computer Vision

In an alternative embodiment, the camera is utilized to capture a multitude of images from various angles around the user's head. These images are then subjected to advanced image analysis algorithms, which meticulously refine the head shape profile by identifying key characteristics such as the scalp's width, length, and curvature. In another embodiment, the system is equipped with Hairline Detection functionality. It accurately identifies the user's hairline, a crucial reference point for any haircut. This precision in detecting the hairline ensures that the haircut is harmoniously aligned with both the natural hairline and the overall head shape.

### When Head Shape and Hair Length Profiling is Occurred

Scalp and hair length profiling is a critical process that can be strategically timed during the haircut. A complete scalp profiling may be necessary primarily at the beginning or the end of the haircut. However, correlating the 3D scalp shape with the hair profile in a coordinate matrix can be executed at any selected moment during the haircutting process. This includes the initial phase, interim stages during the cut, and the final phase. The plurality of sensors and mechanical method employed provide location measurements that enable dynamic adjustment capabilities.

### Dynamic Adjustment and User Movement Accommodation:

The system's viewing assembly is designed to continuously collect data in the head's profile throughout the haircut. This constant surveillance allows the robotic arm to adapt dynamically to the ongoing procedure. Such adaptability is crucial for adjusting to any movements or positional shifts by the user during the haircut. This feature represents a significant improvement of the present invention, as it eliminates the need for the user to remain in a static position throughout the haircut. This flexibility enhances user comfort and improves the haircut's overall precision.

Integration of Hardware Movement with Data Processing:

All data collected from the sensors and camera are continuously integrated and processed in real time. This real-time data integration is critical for guiding the robotic arm and cutting tools accurately. It ensures that each haircut is not only precise but also tailored to the individual's unique head shape. This approach facilitates a customized haircutting experience, adapting to the specific contours and characteristics of each user's scalp and hair profile.

### Safety Features

The second key improvement of the present invention is the safety features. The programmable hair maintenance system is equipped with an advanced safety feature, meticulously designed to mitigate the risk of accidental cuts or injuries to the user. This safety feature encompasses several layers of protection and precautionary measures including a Sensor-Based Cut Prevention and Software Safety Protocols.

### Sensor-Based Cut Prevention

The Sensor-Based Cut Prevention comprises a plurality of sensors strategically embedded within the curved structure or on the robotic arm, tasked with the continuous monitoring of the cutting tools' proximity to the user's skin. These sensors are capable of detecting encroachment of the cutting tools towards the skin. Upon detecting proximity that falls within a previously defined boundary conditions, including but not limited to potentially unsafe threshold distance to a skin, for example, 5-10 mm, the system is programmed to initiate an immediate response. This immediate response involves either an automatic pause in the operation of the cutting tools or an adjustment in their movement trajectory, speed, effectively averting any potential risk of injury to the user.

The Sensor-Based Cut Prevention are selected from temperature sensors, infrared sensors, chemical sensors, specifically designed for blood and color detection, and mechanical sensors capable of detecting pressure and force, or a combination of them. Each sensor type contributes uniquely to the safety mechanism. Temperature sensors monitor for any unusual thermal change or signatures that might indicate excessive friction or proximity to the skin. Infrared sensors are employed to maintain a safe distance between the cutting tools and the scalp, ensuring precision without compromising safety. Chemical sensors are particularly crucial; they are finely tuned to detect the slightest trace of blood or changes in skin color, indicative of potential nicks or cuts. Mechanical sensors, on the other hand, are sensitive to variations in pressure and force, alerting the system to any undue contact or pressure that could result in injury.

When cutting tools, such as scissors or trimmers, venture too close to the scalp or skin, these sensors are designed to immediately detect the risk. They measure parameters like temperature, chemical composition, color, pressure, and force, and compare these with predefined safety thresholds. Upon detecting values that approach or exceed these alert thresholds, the sensors trigger an immediate response in the system. This response could range from generating warnings to the user to activating automated shutdowns or retraction of the cutting tools, thereby preventing any potential harm to the user.

The position of the robotic arm bearing the lifting member and cutting member is constantly controller by the local controller. Additionally, the sensors continuously monitor the interaction between the cutting member and the user's scalp. This vigilant surveillance allows for dynamic adjustments by the system, adapting in real-time to the user's movements and changes in the cutting environment. This level of responsiveness not only enhances safety but also contributes to the precision and quality of the haircut, ensuring a seamless and secure grooming experience.

### Software Safety Protocols

The system's safety measures are further enhanced through the implementation of Software Safety Protocols within its operational software. Central to these protocols is the establishment and consistent enforcement of safe operational parameters for the cutting tools. This approach involves a positional cut technique, where both the user's head shape and the selected hairstyle are meticulously mapped out into a position matrix. Each position within this matrix correlates with specific hair length thresholds.

To ensure safety, the software is configured to identify high risk boundaries and set operational norms that include precautionary measures like issuing alarm signals when approaching high-risk boundaries. An example of such a measure is the reduction of the cutting speed as a cautionary response. These protocols are meticulously engineered to ensure that the cutting tools operate within pre-established safety space margins, effectively reducing the likelihood of risk. Specifically, the pre-established safety space margins includes identifying a minimal length of hair, spacing control to prevent the positional-cut assembly from cutting the hair shorter than a preset minimal length; or defining a near head skin condition, once it met the near head skin condition, the cutting will stop immediately and request confirmation, to prevent hurting the head skin.

Moreover, the software protocols are both responsive and adaptive. They are designed to detect any deviation from the established safe operational norms actively. In situations where a abnormal cut is detected, these protocols are programmed to initiate immediate corrective actions such as a stop. By integrating these features, the user interface would not only allow for the selection of hairstyles but also offer a comprehensive and interactive experience that guides users from selection to actual styling.

### User Interface (UI)

In a first aspect of the invention, the programmable hair maintenance system further comprises a user interface. The user interface enables users to select and input desired hairstyles, particularly catering to those seeking dramatic hairstyle changes.

The user interface (UI) is operational and displayed on a touchscreen. In one embodiment, this interface presents a Visual Gallery feature, showcasing a diverse array of hairstyles categorized by length, style, and texture, allowing users to effortlessly browse and choose a hairstyle that resonates with their preferences.

Additionally, the UI is equipped with a Search and Filter Function, incorporating a search bar alongside various filtering options. Users can refine their hairstyle search based on criteria such as hair length (short, medium, long), type (curly, straight, wavy), and occasion (casual, formal, sporty).

Further enhancing the UI's capabilities, Customization Tools are provided. These tools enable users to personalize selected hairstyles, offering options to adjust length, modify color, add highlights, and experiment with different hair accessories, thereby allowing a high degree of customization.

The UI also integrates a Virtual Try-On feature, utilizing Augmented Reality (AR) technology. This feature allows users to upload their photographs and virtually try on various hairstyles, facilitating a more informed and visual decision-making process.

As an alternative, the UI includes a Personalization Quiz. This feature implements a quiz that gathers information about the user's hair type, face shape, lifestyle, and personal preferences. The UI then utilizes this data to suggest personalized hairstyle options tailored to the user's unique profile.

Additionally, the UI fosters a Community and Feedback environment. This includes a dedicated section where users can view reviews, ratings, and photographs from others who have tried the hairstyles, thereby aiding in the decision-making process through community insights.

The UI further offers Save and Share Options, enabling users to save their preferred hairstyles and share them with friends or their hairstylist via integrated social media platforms.

Lastly, the UI provides Tutorials and Tips. This feature includes various tutorials and guidance on achieving and maintaining the selected hairstyles, along with information on necessary tools and products, thereby supporting users in their hairstyling journey.

UI is a screen. In one embodiment, UI is a touchable screen.

### Local Processing Unit

Further, the programmable hair maintenance system comprises a local processing unit to take input from for determining adjustments to positional-cut assembly based on hair length profile and chosen hairstyle.

In another aspect of the invention, the programmable hair maintenance system is equipped with a local processing unit, a vital component responsible for managing the entire haircutting process. This unit is adept at integrating inputs from a range of sources, most notably the viewing assembly that includes sensors and cameras. These inputs are crucial for constructing a detailed hair length profile of the user, encompassing measurements of hair length across different parts of the head and understanding the overall hair distribution.

Upon a user selecting their desired hairstyle through the user interface, this selection is processed by the local processing unit or remote computer device. The unit comprehensively understands the nuances of the chosen style, including its required shape, length, and texture.

Based on the juxtaposition of the user's current hair length profile and the selected hairstyle, the processing unit calculates precise adjustments needed for the positional-cut assembly. This intricate calculation process ensures that the robotic arm and the cutting assembly are maneuvered with high precision, aligning each cut perfectly to achieve the desired hairstyle, tailored to the user's unique hair characteristics.

Furthermore, the system incorporates a feedback loop mechanism. This mechanism assesses the initial cutting results, allowing the processing unit to recalibrate and adjust the cutting parameters if needed, to refine the haircut and align it more closely with the desired outcome. Importantly, all these functions, from input integration to precision cutting control, are performed in real-time, ensuring a seamless haircutting experience that dynamically adapts to the user's immediate needs.

Moreover, the processing unit significantly enhances the user experience. It is designed to remember user preferences and previous haircut data, facilitating quick and easy replication of favorite styles or incorporating adjustments based on past experiences and feedback.

In one variation of the invention, the viewing assembly is configured to communicate with a local controller. This local controller, in turn, facilitates bidirectional communication with a remote computing device. In an alternate variation, the viewing assembly is designed to communicate directly with the remote computing device. Subsequently, the remote computing device relays instructions to a local slave controller. This configuration is particularly advantageous as it minimizes the storage and processing requirements of the local slave controller and/or an optional processing unit, optimizing overall system efficiency. The local controller and remote computing device in the programmable hair maintenance system acts as the central hub, intelligently managing and executing the haircutting process. It integrates and analyzes various data from the viewing assembly and user interface, calculates necessary adjustments, and precisely controls the positional cut assembly, ensuring each haircut is customized and accurate according to the individual's unique hair profile and style preferences.

The programmable hair maintenance system further comprises a power supply to supply power to the local units including viding assembly, positional cut assembly, sensors cameras and local controller and user interface.

On a second aspect, a method of hair cut is disclosed. The method comprises the steps of activating the programmable hair maintenance system and conducting a calibration check to ensure the robotic arm, lifting member, cutting member, and viewing assembly are functioning correctly; guiding the user to create a profile on the user interface, entering details such as hair type, preferred styles, and other personal preferences; mapping head shape and measuring hair length by positioning the user within the system's working area for within the enclosure of the curved structure of FIG. 2 and utilizing the sensors and camera of the viewing assembly to profile the user's head shape and measure their current hair length; prompting the user to select a hairstyle by assisting the user in choosing a desired hairstyle through the user interface, utilizing the Visual Gallery or Search and Filter Function, and offering a preview with the Virtual Try-On feature if desired; or skipping this search and filter function step and just maintaining the current hair style.

The method further comprises initiating an automated haircut: Begin the automated cutting process, where the robotic arm and positional-cut assembly adjust according to the user's head profile and selected hairstyle, with continuous monitoring and adjustment.

The method further comprises monitor safe cutting by actively engaging the system's safety features, including Sensor-Based Cut Prevention and Software Safety Protocols, to prevent potential risks throughout the haircut.

Elements of the disclosure are listed below.
Vertical support member 1011 of the support assembly 1010
Vertical support member 2021 of the support assembly 2010
Lateral support member 1012 of the support assembly 1010
Lateral support member 2022 of the support assembly 2010
Lateral support member 1012 of the support assembly 1010
Lateral support member 2022 of the support assembly 2010
Guiding member 1013 of the support assembly 1010
Guiding member 2023 of the support assembly 2010
Robotic arm 1014 of the support assembly 1010
Robotic arm 2014 of the support assembly 2010
Positional cut assembly 1015 of the support assembly 1010
Positional cut assembly 2025 of the support assembly 2010
Positional cut assembly 1015 of the support assembly 1010
Positional cut assembly 2025 of the support assembly 2010
Lifting member 1016, cutting member 1017 of positional cut assembly 1015
Lifting member 2026, cutting member 2027 of positional cut assembly 2025
Bridge 1018 between lateral member and guiding member
Rail 1019 inside of the guiding member 1013
Rail 2029 enclosed in the guiding member 2023, ring member
Camera 2031, sensor 2032
viewing assembly 2030
user interface 1033 and 2033

### Detail Application Example

### Assisting Elderly and Disabled Individuals

Description: George, a 75-year-old retiree, faces challenges with mobility due to arthritis, which complicates his regular visits to a barber. His daughter, Anne, is constantly seeking solutions to aid George in maintaining his grooming routine while minimizing physical discomfort. The programmable hair cutting module emerges as an ideal solution, specifically tailored to meet George's unique needs.

### Usage Scenario:

System Acquisition and Setup step: Anne acquires the programmable hair cutting module for her father and installs it in their home, ensuring it is readily accessible for George, when he is siting down.

Calibration for Precision step: With Anne's assistance, George calibrates the system's sensors and cameras to precisely capture his head shape and hair length, ensuring accurate data for a customized haircut.

Hairstyle Selection step: Through the user-friendly interface, Anne aids George in choosing his preferred hairstyle from a familiar or an extensive library of options, accommodating his personal style preferences.

Automated Data Processing step: The remote computer device processes the input data, calculating necessary adjustments to the cutting tools in alignment with George's selected hairstyle for a precise cut; send instruction to a local slave controller which controls the positional cut assembly.

Efficient and Safe Haircutting step: George enters into the curved structure, whereupon the positional based cutting assembly skillfully perform the haircut, ensuring accuracy and safety.

Post-Haircut Maintenance: Post haircut, Anne assists George with exiting the curved structure and conducts a thorough cleaning of the lifting and cutting members, preparing it for future use.

In the scope of the present invention, the local controller, remote computer device, slave controller, processing unit are all one or more processors. The steps of mapping and calculating are performed by one or more processors.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to explain the principles of the invention and its practical applications, they thereby enable others skilled in the art to utilize the invention and various embodiments with various modifications as are suited to the particular use contemplated. It is intended that the following claims and their equivalents define the scope of the invention. While this invention has been described in terms of several preferred embodiments, there are alterations, modifications, permutations, and substitute equivalents, which fall within the scope of this invention. It should also be noted that there are many alternative ways of implementing the methods and apparatuses of the present invention. It is therefore intended that the following appended claims be interpreted as including all such alterations, permutations, and substitute equivalents as fall within the true spirit and scope of the present invention.

1-13. (canceled)

14. A computer-implemented method for cutting hair from a user's head, comprising:
[a] providing a programmable robotic hair maintenance system replacing a human barber, comprising
a guiding member and a positional-cutting assembly,
[b] supporting the positional-cut assembly through a support assembly from a support surface, comprising a lateral support member configured to move in a 1-100 meters range, in order to allow the user, take a hair cut while sitting down or standing up;
[c] moving the positional-cut assembly along with curvature rails of the guiding member in a range of ±50 cm;
[d] positioning a user's head in a cavity surrounded by the guiding member;
[e] eliminating a need for the user to remain stationary in a fixed position and accommodating head movements or positional shifts made by the user within the context of the haircutting process;
[f] continuously monitoring through the viewing assembly about the head movements and positional shifts made by the user and dynamically adjusting a position and orientation of the positional-cut assembly in responsive to the head movements and positional shifts;
[g] creating a profile of the user's head by a remote computing device based on data collected through the viewing assembly including cameras and sensors, a data file including geometry, texture, and hair length, with positions across the user's head;
[h]
[i] receiving a request from a user interface about maintenance needs including style, length; by the remote computing device, determining a length profile of the hair across the base shape of the head and send instructions including position and length data to a slave controller through wireless communication; and
[j] sending operable instructions from the slave controller to the positional-cut assembly,
[k] moving a robotic arm in five degrees of freedom,
[l] holding a strand of hair by a lifting member, and executing cutting using a cutting member.

15. The method for hair maintenance of claim 14, wherein the user interface includes a library of preset hairstyles for user selection.

16. The method for hair maintenance of claim 14, wherein the user interface allows for uploading custom hairstyles.

17. (canceled)

18. The method for hair maintenance of claim 14, further comprising a step of preventing accidental cutting by identifying high risk boundaries including ears, hairlines, and set operational norms including reducing the cutting speed and changing approaching angle of the positional cut assembly, when approaching the high risk boundaries.

19. The method for hair maintenance of claim 14, further comprising providing spacing control, configured through the remote computing device taking input from the viewing assembly to prevent the positional-cut assembly from cutting the hair shorter than a preset minimal length or from hurting the head skin.

20. The method for hair maintenance of claim 14, further comprising collecting removed hairs through the lifting member.

21. (canceled)

22. The method for hair maintenance of claim 14, further comprising maneuvering the positioning cut assembly, including the lifting member and cutting member, both vertically, up and down, and horizontally, left and right, and to tilt with an operational range of ±35 degrees.

23. The method for hair maintenance of claim 14, further comprising
embedding a plurality of sensors of the viewing assembly within the curved structure and on the robotic arm, ensuring a maximum coverage of the enclosed area of the curved structure and sensitivity to prevent accidental cuts or injury during the haircutting process;
continuously monitoring a proximity of the cutting member to the user's skin;
detecting encroachment of the cutting member towards the user's skin, the sensors identifying proximity falling within previously defined boundary conditions, including an unsafe threshold distance of 5-10 mm; and
automatically pausing an operation of the cutting member upon detecting unsafe proximity; and initiating an immediate response to the user interface.

24. The method for hair maintenance of claim 14, further comprising
measuring parameters including temperature, chemical composition, color, pressure, and force, using a plurality of sensors to compare these with predefined safety thresholds, comprising the steps of:
monitoring for unusual thermal changes or signatures that indicate excessive friction or proximity to the skin by using temperature sensors;
employing the infrared sensors to maintain a safe distance between the cutting tools and the scalp, ensuring precision without compromising safety;
detecting a trace of blood or changes in skin color, to identify potential cuts; using mechanical sensors capable of alerting the programmable robotic hair maintenance system to any undue contact or pressure which will result in injury.

25. The method for hair maintenance of claim 14, wherein the step of creating a profile of the user's head by a remote computing device, a data file including both geometry, texture, and hair length with positions across the user's head comprising
using the lifting member to lift a hair strand at specific scalp locations, moving from one end of the hair strand to the other end, measuring a length of the hair strand.
